(19) United States
(12) Patent Application Publication
(10) Pub. No.: US 2025/0003893 A1
(43) Pub. Date: Jan. 2, 2025

(54) METHOD FOR MONITORING INFLUENCE OF DEFECTS IN FEW-LAYER TWO-DIMENSIONAL MATERIAL ON EXCITON TRANSPORT

(71) Applicant: Tsinghua University, Beijing City (CN)

(72) Inventors: Dameng Liu, Beijing City (CN); Huan Liu, Beijing City (CN); Chong Wang, Beijing City (CN); Jianbin Luo, Beijing City (CN)

(21) Appl. No.: 18/706,241

(22) PCT Filed: Oct. 30, 2020
(86) PCT No.: PCT/CN2020/125421

§ 371 Date: Jul. 25, 2024

(30) Foreign Application Priority Data
Oct. 30, 2019 (CN) 201911059804.8

(51) Int. Cl. G01N 23/18; G01N 21/63; G01N 21/95; G01N 23/04

(52) U.S. Cl. CPC G01N 23/18; G01N 21/636; G01N 21/9501; G01N 23/04; G01N 2223/102; G01N 2223/418; G01N 2223/646

(57) ABSTRACT

Disclosed is a method for monitoring the influence of defects in a few-layer two-dimensional material on exciton transport. The method includes: measuring an original few-layer two-dimensional material sample to obtain a first transient absorption dynamic curve; fitting the first transient absorption dynamic curve to obtain a first exciton lifetime; acquiring first TAM images of exciton densities at different delay times; fitting the first TAM images to determine a first diffusion coefficient and a first diffusion distance; performing plasma treatment on the original few-layer two-dimensional material sample for different durations, and obtaining a second transient absorption dynamic curve; fitting the second transient absorption dynamic curve to obtain a second exciton; acquiring and fitting second TAM images of exciton densities at different delay times to determine a second diffusion coefficient and a second diffusion distance; and monitoring the influence of defects on exciton transport.

### TECHNICAL FIELD

The present disclosure relates to techniques of the exciton transport dynamics in nanomaterials, in particular to a method for monitoring the influence of defects in a few-layer two-dimensional material on exciton transport.

### BACKGROUND

The original two-dimensional transition metal dichalcogenide (TMDC) have been widely used in a variety of nano-optoelectronic components, including the light-emitting diode, the exciton transistor, the photovoltaic application, etc. Nanoscale energy transfer in the form of excitons is at the core of these TMDC-based devices. For example, in the spot light application, excitons are generated by optical excitation and then must efficiently move to an interface at which the exciton dissociate to generate a photovoltage or photocurrent. However, in existing components, defects are always introduced during pre-processing and nanofabrication of 2D (2 dimensional) TMDCs. The defects may affect the energy-band structure, crystal structure, and exciton transport, and thus affect the performance of the component. Especially for 2D TMDCs, the interfacial defects have a great impact on exciton dynamics because there are only a few atomic layers on the surface, which leads to an increased probability of defect scattering compared to the bulk crystal.

The exciton diffusion distance is related to the exciton lifetime and diffusion coefficient. The carrier and exciton dynamics of 2D TMDCs have been significantly modulated by various types of defects, including the vacancy, the boundary, the dopant, the substrate, the physisorption or chemisorption of molecule, and so on. These defects may act as trapping centers of carriers and excitons, which has a significant impact on the recombination lifetime of excitons. Furthermore, exciton diffusion constants of original 2D TMDCs have been measured by pump-probe spectroscopy and photoluminescence (PL) techniques, with the range being 0.3 cm²s⁻¹ to 60 cm²s⁻¹. However, direct imaging measurements of exciton diffusion affected by defects have been scarce to date. Therefore, a complete understanding of the interaction between defects and exciton transport in defective 2D TMDCs remains challenging. When the component performance in 2D TMDCs is optimized, it is critical to understand how defects affect the exciton diffusion distance.

### SUMMARY

The present disclosure provides a method for monitoring the influence of defects in a few-layer two-dimensional material on exciton transport, which monitor the change of exciton transport of a sample under different plasma treatment times by TAM (transient absorption microscope) imaging, to quickly and intuitively measure the influence of the defects on exciton transport.

In order to realize the above purpose, an embodiment of the present disclosure provides a method for monitoring the influence of defects in a few-layer two-dimensional material on exciton transport. The method includes:
measuring a pre-acquired original few-layer two-dimensional material sample using a transient absorption microscope to obtain a first transient absorption dynamic curve;
fitting the first transient absorption dynamic curve to obtain a first exciton lifetime of the original few-layer two-dimensional material sample;
acquiring first TAM images of exciton densities of the original few-layer two-dimensional material sample at different delay times by using a pump beam and a probe beam of the transient absorption microscope;
fitting the first TAM images using a Gaussian function to determine a first diffusion coefficient and a first diffusion distance of excitons in the original few-layer two-dimensional material sample;
performing plasma treatment on the original few-layer two-dimensional material sample for different durations, and measuring the plasma-treated original few-layer two-dimensional material sample using the transient absorption microscope to obtain a second transient absorption dynamic curve;
fitting the second transient absorption dynamic curve using a double exponential function to obtain a second exciton lifetime of the plasma-treated sample;
acquiring second TAM images of exciton densities of the plasma-treated sample at different delay times by using the pump beam and the probe beam of the transient absorption microscope;
fitting the second TAM images using the Gaussian function to determine a second diffusion coefficient and a second diffusion distance of excitons in the plasma-treated sample; and
monitoring the influence of the defects on exciton transport based on the first exciton lifetime, the first diffusion coefficient, the first diffusion distance, the second exciton lifetime, the second diffusion coefficient and the second diffusion distance.

In one embodiment, the acquiring the first TAM images of exciton densities of the original few-layer two-dimensional material sample at different delay times by using the pump beam and the probe beam of the transient absorption microscope includes:
fixing a position of the pump beam of the transient absorption microscope, irradiating the original few-layer two-dimensional material sample by the pump beam, and scanning the original few-layer two-dimensional material sample by the probe beam, to acquire the first TAM images of exciton densities at different delay times.

In one embodiment, the acquiring the second TAM images of exciton densities of the plasma-treated sample at different delay times by using the pump beam and the probe beam of the transient absorption microscope includes: irradiating the plasma-treated sample by the pump beam, and scanning the plasma-treated sample by the probe beam, to acquire the second TAM images of exciton densities at different delay times.

In one embodiment, the monitoring the influence of the defects on exciton transport based on the first exciton lifetime, the first diffusion coefficient, the first diffusion distance, the second exciton lifetime, the second diffusion coefficient and the second diffusion distance includes: comparing the first exciton lifetime, the first diffusion coefficient and the first diffusion distance with the second exciton lifetime, the second diffusion coefficient and the second diffusion distance that are under different defect concentrations, respectively, to monitor a change of the diffusion distance under different defect concentrations.

In one embodiment, the performing plasma treatment on the original few-layer two-dimensional material sample for different durations includes: processing the original few-layer two-dimensional material sample in argon plasma of 10 W at a radio frequency of 13.56 MHz.

In one embodiment, the method further includes: identifying defects that are introduced by performing the plasma treatment on the original few-layer two-dimensional material sample for different durations.

In one embodiment, the identifying the defects that are introduced by performing the plasma treatment on the original few-layer two-dimensional material sample for different durations includes: characterizing, after performing the plasma treatment on the original few-layer two-dimensional material sample for different durations, sample defects by an atomic resolution scanning transmission electron microscope and a photoluminescence technique to determine whether the defects have been introduced.

In one embodiment, during the fitting the first TAM images using the Gaussian function to determine the first diffusion coefficient and the first diffusion distance of excitons in the original few-layer two-dimensional material sample, the total number n (x, y, t) of the excitons is:

$$\frac{n ( x , y , t )}{\partial t} = D [ \frac{\partial {n}^{2} ( x , y , t )}{\partial {x}^{2}} + \frac{\partial {n}^{2} ( x , y , t )}{\partial {y}^{2}} ] - \frac{n ( x , y , t )}{τ}$$

where D denotes the first diffusion coefficient, n (x, y, t) denotes the total number of the excitons of a function with time t and position (x, y), and τ denotes an exciton lifetime and includes radiative recombination and non-radiative recombination.

In one embodiment, the few-layer two-dimensional material is few-layer WS₂.

In one embodiment, the pump beam has a wavelength of 400 nm and an energy density of 3.20 μJ/cm², and the probe beam has a wavelength of 625 nm and an energy density of 0.19 μJ/cm².

The present disclosure can monitor the change of exciton transport of the sample under different plasma treatment times by TAM imaging, and can quickly and intuitively measure the influence of the defects on exciton transport, which provides guidance for optimizing the performance of related components.

### BRIEF DESCRIPTION OF THE DRAWINGS

In order to more clearly illustrate the technical solutions of the embodiments of the present disclosure, the drawings to be used in the description of the embodiments will be briefly introduced below. Obviously, the drawings in the following description only illustrate some embodiments of the present disclosure, and those of ordinary skill in the art may obtain other drawings from them without paying any creative effort. In the drawings:

FIG. 1 shows a flowchart of a method for monitoring the influence of defects in a few-layer two-dimensional material on exciton transport according to an embodiment of the present disclosure.

FIG. 2 shows schematic diagrams of identification of vacancy defects, where picture (a) is a scanning electron microscope (SEM) image of a WS₂ thin slice suspended on a fractal porous carbon-gate; pictures (b) and (c) show a comparison between aberration-corrected scanning transmission electron microscope images of the original WS₂ and the WS₂ with defects, and sulfur vacancies are marked by circles in the picture; and picture (d) is a steady state PL (Photoluminescence) spectral image of the original WS₂ and the WS₂ with defects.

FIG. 3 shows schematic diagrams of exciton dynamics of defect modulation, where picture (a) is a schematic diagram of transient absorption microscope (TAM) apparatuses (AOM: acousto-optic modulator; BBO: β-BaB2O4; APD: avalanche photodiode; and wavelengths of a pump beam and a probe beam are 400 nm and 625 nm, respectively) for exciton dynamics and transport measurement; picture (b) shows transient absorption dynamic curves of performing plasma treatment on few-layer WS2 on a glass substrate for different durations (0 s, 10 s, 30 s, and 40 s), energy densities of the pump beam and the probe beam being 3.20 μJ/cm² and 0.19 μJ/cm², respectively, and the black curves being fitted curves described by a double exponential function; picture (c) is lifetimes of a long lifetime component and a short lifetime component as a function of plasma treatment time; picture (d) is a lifetime weight as a function of plasma treatment time; and picture (e) is a principle diagram of ultrafast exciton dynamics in the 2D WS₂ with defects.

FIG. 4 shows visual schematic diagrams of exciton transport in original WS₂, where picture (a) is a two-dimensional transient absorption microscope image of original few-layer WS₂ at different delay times, energy densities of a pump beam and a probe beam being 3.20 μJ/cm² and 0.19 μJ/cm², respectively; picture (b) shows good fitting of a cross-section through a center of a TAM image along a horizontal axis using a Gaussian function; and picture (c) is a diffusion coefficient of the original few-layer WS₂ obtained from a variance (σ_{x,t}²) of the Gaussian distribution.

FIG. 5 shows a comparison of exciton transport in original WS₂ and WS₂ with defects, where picture (a) is a two-dimensional transient absorption microscope (TAM) image of the few-layer WS₂ with defects at different delay times, the fluence of a pump beam and a probe beam being 3.20 μJ/cm² and 0.19 μJ/cm², respectively, a sample being treated with continuous argon ion bombardment at 10 W for 40 s, for the delay time >0 ps, the maximum signal being normalized to the maximum signal at 0 ps, and the multiplicity of the color scale of each image being marked; pictures (b) and (c) show fitting of cross-sections of TAM images of the original WS₂ and the WS₂ with defects along an x axis through a Gaussian function; and picture (d) is an surface diagrams of two-dimensional TAM images of the original WS₂ and the few-layer WS₂ with defects at different delay times.

FIG. 6 shows exciton diffusion coefficients and diffusion distances of a sample under different plasma treatment times, where (a) is a time evolution diagram of a variance of Gaussian distribution under different plasma treatment times (0 s, 10 s, 30 s, and 40 s); and (b) is a diffusion distance of excitons in a few-layer WS₂ under different plasma treatment times.

### DESCRIPTION OF THE EMBODIMENTS

The technical solutions of the embodiments of the present disclosure will be clearly and completely described below with reference to the drawings of the embodiments of the present disclosure. Obviously, the embodiments described are merely a part of the embodiments of the present disclosure, rather than all the embodiments. Based on the embodiments of the present disclosure, all other embodiments obtained by a person of ordinary skill in the art without any creative effort shall fall within the scope of protection of the present disclosure.

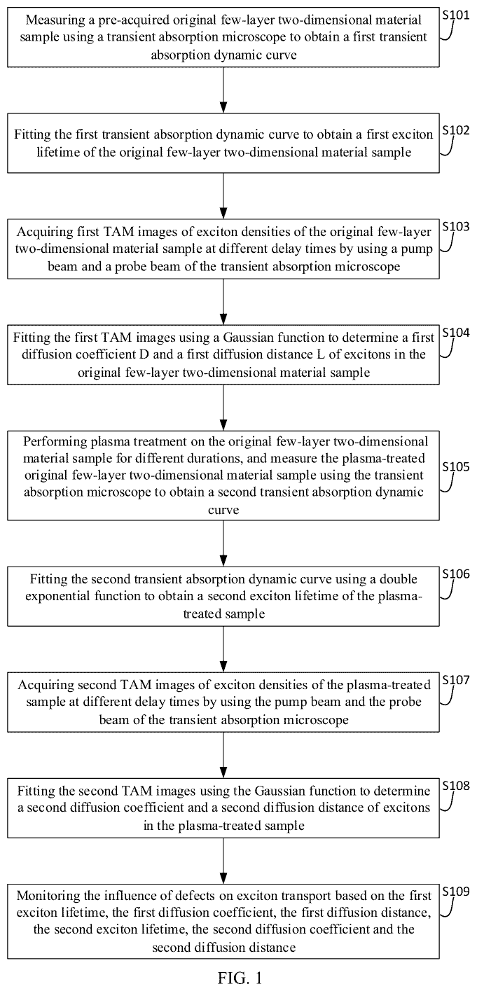

FIG. 1 is a flowchart of a method for monitoring the influence of defects in a few-layer two-dimensional material on exciton transport according to an embodiment of the present disclosure. As shown in FIG. 1, the method includes the following steps:

S101: measuring a pre-acquired original few-layer two-dimensional material sample using a transient absorption microscope to obtain a first transient absorption dynamic curve.

The few-layer two-dimensional material sample may be a sulfide sample (WS₂), and the present disclosure is not limited thereto.

S102: Fitting the first transient absorption dynamic curve to obtain a first exciton lifetime of the original few-layer two-dimensional material sample.

In one embodiment, the first transient absorption dynamic curve may be fitted using a single exponential function, and the first exciton lifetime t of the original few-layer two-dimensional material sample may be obtained based on the first transient absorption dynamic curve.

S103: Acquiring first TAM images of exciton densities of the original few-layer two-dimensional material sample at different delay times by using a pump beam and a probe beam of the transient absorption microscope.

S104: Fitting the first TAM images using a Gaussian function to determine a first diffusion coefficient D and a first diffusion distance L of excitons in the original few-layer two-dimensional material sample.

S105: Performing plasma treatment on the original few-layer two-dimensional material sample for different durations, and measure the plasma-treated original few-layer two-dimensional material sample using the transient absorption microscope to obtain a second transient absorption dynamic curve.

In order to introduce defects of the original few-layer two-dimensional material sample, it is necessary to perform plasma treatment on the original few-layer two-dimensional material sample for different durations. After the introduction of the defects, the plasma-treated original few-layer two-dimensional material sample is measured using the transient absorption microscope to obtain the second transient absorption dynamic curve.

In one embodiment, the defects that are introduced by performing the plasma treatment on the original few-layer two-dimensional material sample for different durations are identified. During the specific implementation, after the plasma treatment is performed on the original few-layer two-dimensional material sample for different durations, sample defects may be characterized by an atomic resolution scanning transmission electron microscope and a photoluminescence technique to determine whether defects have been introduced.

S106: Fitting the second transient absorption dynamic curve using a double exponential function to obtain a second exciton lifetime of the plasma-treated sample.

The double exponential function may be A₁e^{-t/τ}^{₁}+A₂e^{-t/τ}^{₂}, where A₁ and A₂ denote normalized amplitude components, Ti denotes a decay lifetime corresponding to a normalized amplitude component Aᵢ of (i=1, 2), and t denotes the decay time. By fitting the second transient absorption dynamic curve using A₁e^{-t/τ}^{₁}+A₂e^{-t/τ}^{₂}, the exciton lifetimes of the sample treated by the plasma for different durations may be obtained separately.

S107: Acquiring second TAM images of exciton densities of the plasma-treated sample at different delay times by using the pump beam and the probe beam of the transient absorption microscope.

S108: Fitting the second TAM images using the Gaussian function to determine a second diffusion coefficient and a second diffusion distance of excitons in the plasma-treated sample.

S109: Monitoring the influence of defects on exciton transport based on the first exciton lifetime, the first diffusion coefficient, the first diffusion distance, the second exciton lifetime, the second diffusion coefficient and the second diffusion distance.

As can be seen from the flow shown in FIG. 1, in the present disclosure, the exciton lifetimes, diffusion coefficients and diffusion distances before and after the introduction of defects in the few-layer two-dimensional material are acquired, and the influence of the defects on exciton transport is monitored based on the exciton lifetimes, diffusion coefficients and diffusion distances before and after the introduction of defects in the few-layer two-dimensional material. By means of the present disclosure, the change of exciton transport of the sample under different plasma treatment times may be monitored by TAM imaging, and the influence of defects on exciton transport may be quickly and intuitively measured.

In one embodiment, the acquiring the first TAM images of exciton densities of the original few-layer two-dimensional material sample at different delay times by using the pump beam and the vibrating mirror of the transient absorption microscope includes:
fixing a position of the pump beam of the transient absorption microscope, irradiating the original few-layer two-dimensional material sample by the pump beam, and scanning the original few-layer two-dimensional material sample by the vibrating mirror, to acquire the first TAM images of exciton densities at different delay times.

In one embodiment, the acquiring the second TAM images of exciton densities of the plasma-treated sample at different delay times by using the pump beam and the vibrating mirror of the transient absorption microscope includes: irradiating the plasma-treated sample by the pump beam, and scanning the plasma-treated sample by the vibrating mirror, to acquire the second TAM images of exciton densities at different delay times.

In one embodiment, the monitoring the influence of the defects on exciton transport based on the first exciton lifetime, the first diffusion coefficient, the first diffusion distance, the second exciton lifetime, the second diffusion coefficient and the second diffusion distance includes: comparing the first exciton lifetime, the first diffusion coefficient and the first diffusion distance with the second exciton lifetime, the second diffusion coefficient and the second diffusion distance that are under different defect concentrations, respectively, to monitor a change of the diffusion distance under different defect concentrations. The larger the concentration of the defect, the shorter the exciton lifetime, the smaller the diffusion coefficient, and the shorter the diffusion distance.

In one embodiment, the performing plasma treatment on the original few-layer two-dimensional material sample for different durations includes: processing the original few-layer two-dimensional material sample in argon plasma of 10 W at a radio frequency of 13.56 MHz.

In one embodiment, during the fitting the first TAM images using the Gaussian function to determine the first diffusion coefficient and the first diffusion distance of the excitons in the original few-layer two-dimensional material sample, the total number n (x, y, t) of the excitons is:

$$\frac{n ( x , y , t )}{\partial t} = D [ \frac{\partial {n}^{2} ( x , y , t )}{\partial {x}^{2}} + \frac{\partial {n}^{2} ( x , y , t )}{\partial {y}^{2}} ] - \frac{n ( x , y , t )}{τ}$$

where D denotes the first diffusion coefficient, n (x, y, t) denotes the total number of the excitons of a function with time t and position (x, y), and τ denotes the exciton lifetime and includes radiative recombination and non-radiative recombination.

The total number of excitons at the initial decay time and at any decay time t is described by

$$n ( x , y , 0 ) = N exp [ - \frac{{( x - {x}_{0} )}^{2}}{2 {σ}_{x , 0}^{2}} - \frac{{( y - {y}_{0} )}^{2}}{2 {σ}_{y , 0}^{2}} ] and n ( x , y , t ) = N exp [ - \frac{{( x - {x}_{0} )}^{2}}{2 {σ}_{x , t}^{2}} - \frac{{( y - {y}_{0} )}^{2}}{2 {σ}_{y , t}^{2}} ] ,$$

where σ_{x,t}² and σ_{y,t}² denote variances of the Gaussian distribution along the x direction and y direction over time, σ_{x,t}²=σ_{x,0}²+L²=σ_{x,0}²+αDt along the x axis, and the diffusion coefficient D is given by

$$D = \frac{{σ}_{x , t}^{2} - {σ}_{x , 0}^{2}}{4 t} ;$$

and when t=τ, the diffusion distance L is defined over the exciton lifetime and is given by L=2\sqrt{Dτ}.

In one embodiment, the pump beam has a wavelength of 400 nm and an energy density of 3.20 μJ/cm², the probe beam has a wavelength of 625 nm and an energy density of 0.19 μJ/cm², and the present disclosure is not limited thereto.

The method for monitoring the influence of defects in the few-layer two-dimensional material on exciton transport according to the present disclosure may be applied to optimize the performance of a component based on a two-dimensional material, and the component based on the two-dimensional material may be a light-emitting diode or an exciton transistor.

In order to further understand the present disclosure, the method and the effects of the present disclosure are described in further detail below in connection with specific embodiments. These embodiments are only exemplary descriptions of the present disclosure, but the present disclosure is not limited thereto.

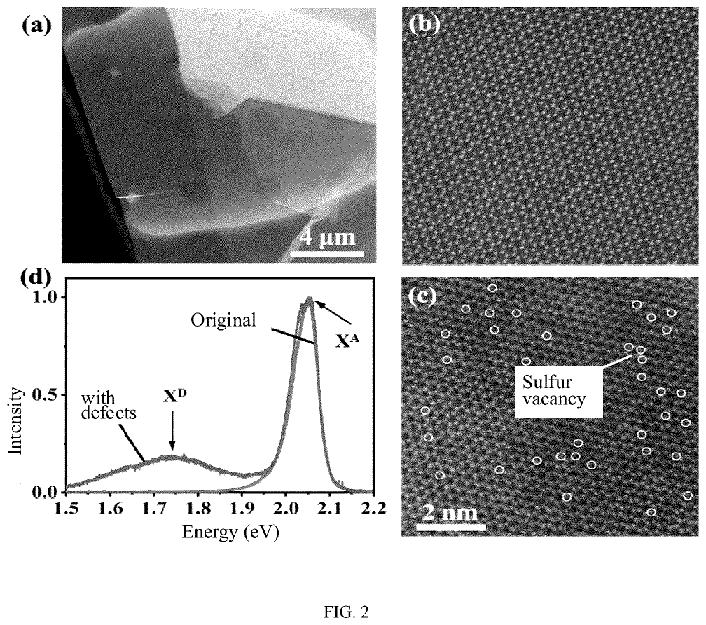

In FIG. 2, (a) shows an original few-layer WS₂ thin slice (the original few-layer two-dimensional material sample) mechanically exfoliated from a bulk crystal on a fractal-hole carbon-gate or a glass substrate. The sample was characterized by optical contrast, Raman spectroscopy, and an atomic force microscope. (b) is a picture of a defect-free lattice structure of the original few-layer WS₂ sample shown by an atomic resolution scanning transmission electron microscope (STEM). Defects were introduced by processing the original few-layer WS₂ sample in argon plasma of 10 W under the radio frequency of 13.56 MHz for 10 s. A plurality of sulfur vacancies are observed in the WS₂ with defects, as described by the white circle markers in (c).

A comparison of the steady-state PL spectra of the original few-layer WS₂ and the few-layer WS₂ with defects is shown in (d) of FIG. 2, and the spectra may be obtained using laser with 532 nm for excitation at 77 K. Both the original few-layer WS2 sample and the few-layer WS₂ sample with defects show the PL peak of a neutral A exciton at 2.05 eV, which is equivalent to the direct band gap of the K point in the Brillouin region. In contrast, the defects introduce a new defect-induced emission peak at 1.75 eV below the PL peak of the neutral exciton. The new PL peak may be attributed to that the defects bind the neutral exciton to form a defect bound exciton, from which it can be determined whether defects have been introduced in the original few-layer WS₂ sample under argon plasma treatment of 10 W at the radio frequency of 13.56 MHz.

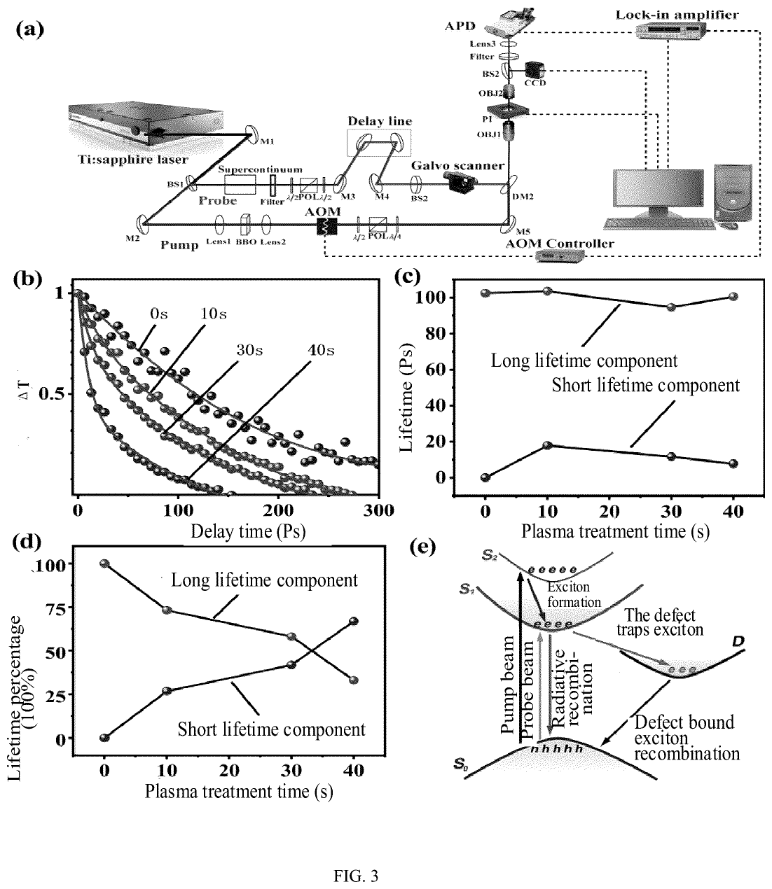

The influence of defects on exciton dynamics is measured by the transient absorption microscope, as shown by (a) of FIG. 3, where an output beam (800 nm) of a Ti: sapphire oscillator (500 mW, 80 MHz) in the TAM device is split into two beams by a 90/10 beam splitter. The stronger beam is frequency multiplication by a β-BaB2O4 (BBO) to be used as a pump, the other slightly weaker beam is used for generating supercontinuum white light, and a beam with the wavelength of 625 nm filtered through the white light is used as the probe beam. The frequency of the pump beam is modulated to 1 MHz by an acousto-optic modulator (AOM) triggered by a lock-in amplifier. The co-linear pump beam and probe beam are focused onto the two-dimensional WS₂ sample, and the probe beam is delayed with respect to the pump beam after linear displacement. The change in transmittance of the probe beam caused by pumping (ΔT=T irradiated by the pump beam-T not irradiated by the pump beam) is detected by an avalanche photodiode (APD), and the signal is recorded by the lock-in amplifier.

Picture (b) in FIG. 3 shows transient absorption (TA) dynamic curves of few-layer WS₂ under different plasma treatment times, where the pump wavelength is 400 nm, and the fluence is 3.20 ρJ/cm². Defects induced by different plasma treatment times (0 s, 10 s, 20 s, and 40 s) lead to differences in exciton dynamics. The wavelength of the probe beam is selected as 625 nm, which resonates with the energy level of the neutral A exciton, and the fluence is 0.19 μJ/cm². Therefore, the transient absorption dynamic curves mainly reflect the dynamics of the A exciton. For the original sample, the lifetime τ₁ of 102.44 ps may be obtained by fitting the TA curves with a single exponential function. After plasma treatment, the exciton dynamics of the A exciton changes faster compared with the original sample. These TA curves of the few-layer WS₂ sample with defects are well fitted by using a double exponential function A₁e^{-t/τ}^{₁}+A₂e^{-t/τ}^{₂}, where τᵢ (i=1, 2) is the decay lifetime corresponding to a normalized amplitude component Aᵢ thereof. As the plasma treatment time increases, the long lifetime component changes very little (close to 100 ps), as shown in (c) of FIG. 3. Meanwhile, a faster exciton decay component re is observed in the few-layer WS₂ sample with defects. This is consistent with the result that the CVD (chemical vapor deposition)-grown WS₂ samples with more defects have faster exciton decay than the exfoliated WS₂ with fewer defects. Moreover, the short lifetime component is reduced to 7.75 ps from 17.88 ps in FIG. 3(c).

The present disclosure attributes the long lifetime component (about 100 ps) to the radiative recombination of the neutral A exciton in (e) of FIG. 3. Some reports indicate that the radiative recombination lifetime of the A exciton is in the range of 100 to 1000 ps. In addition, the short lifetime component (7.75 to 17.88 ps) is attributed to the process of trapping excitons by defects. The obtained results are consistent with the time scales of trapping excitons by defects in two-dimensional MoS₂ and MoSe₂. As the plasma treatment time increases, the lifetime weight of the exciton radiative recombination decreases from 100% to 33% in (d) of FIG. 3. In contrast, the lifetime weight of trapped excitons by the defects increases, indicating that the defect density is proportional to the number of bound excitons.

The short lifetime cannot be attributed to defect-assisted non-radiative recombination, in which defects first trap carriers and then dissipate energy thereof through non-radiative recombination. Since the wavelength of the probe beam during the measurement is close to the energy level of the A exciton, the transient absorption dynamic curve may reflect the decrease in the number of excitons, which is caused by the process of defects trapping excitons instead of trapping carriers. (e) of FIG. 3 shows a principle diagram of ultrafast exciton dynamics in the WS₂ with defects corresponding to a pump beam of 3.10 eV and a probe beam of 1.98 eV. Excited hot carriers are injected to form neutral excitons. The neutral excitons may dissipate energy by radiative recombination of about 100 ps or defect trapping centers. The defects trap neutral excitons (7.75 to 17.88 ps) to form bound excitons, so as to return to the ground state via radiative or non-radiative recombination channels.

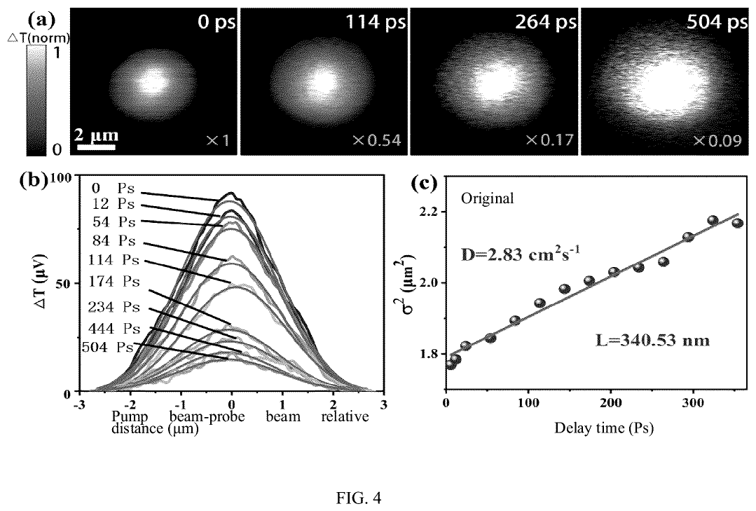

The excitons migrate, scatter and subsequently dissipate energy through the radiative or non-radiative channels at a finite distance from the initial position. To directly image exciton transport, the pump beam (400 nm) is fixed at one position and the probe beam (625 nm) scans the sample through the vibrating mirror in picture (a) of FIG. 3. The change in the differential transmittance of the probe beam induced by the pump beam is obtained under the known pump-probe delay time, and then an image is obtained, where the pump laser is modulated to 1 MHz to avoid laser noise. (a) of FIG. 4 shows representative TAM images of the exciton densities of the original few-layer WS₂ at different delay times (0 ps, 114 ps, 264 ps, and 504 ps), where the maximum signal is normalized to the maximum signal at 0 ps. The TAM image reflects the initial exciton density generated by pump excitation at the delay time of 0 ps. Later, excitons diffuse from the initial volume, which corresponds to the overall distribution of excitons scattered from the center in the TAM image.

In order to quantify the exciton diffusion coefficient, the total number of excitons in the time and in the space may be extracted from TAM measurement results by means of a diffusion model. The model has been widely used to analyze carrier and exciton transport in organic semiconductors and chalcogenides in TAM measurements. The total number of excitons, as a function of time and space, may be described by the following differential equation:

$$\frac{n ( x , y , t )}{\partial t} = D [ \frac{\partial {n}^{2} ( x , y , t )}{\partial {x}^{2}} + \frac{\partial {n}^{2} ( x , y , t )}{\partial {y}^{2}} ] - \frac{n ( x , y , t )}{τ} \qquad ( 1 )$$

where D denotes the exciton diffusion coefficient, n (x, y, t) denotes the total number of excitons as a function of time t and position (x, y), and τ denotes the exciton lifetime and includes radiative recombination and non-radiative recombination The solution of equation (1) is a Gaussian distribution, which represents the change of exciton diffusion with delay time. The total number of excitons at the initial decay moment and at any decay moment t is given by equations (2) and (3):

$$n ( x , y , 0 ) = N exp [ - \frac{{( x - {x}_{0} )}^{2}}{2 {σ}_{x , 0}^{2}} - \frac{{( y - {y}_{0} )}^{2}}{2 {σ}_{y , 0}^{2}} ] \qquad ( 2 )$$

$$n ( x , y , t ) = N exp [ - \frac{{( x - {x}_{0} )}^{2}}{2 {σ}_{x , t}^{2}} - \frac{{( y - {y}_{0} )}^{2}}{2 {σ}_{y , t}^{2}} ] \qquad ( 3 )$$

where σ_{x,t}² and σ_{y,t}² denote variances of the Gaussian distribution along the x and y directions over time, and N is a constant. The exciton diffusion distance L and diffusion coefficient D are related to these variations.

Along the x-axis:

$${σ}_{x , t}^{2} = {σ}_{x , 0}^{2} + {L}^{2} = {σ}_{x , 0}^{2} + a D t \qquad ( 4 )$$

where a is a constant and depends on the dimensionality of a material. For a two-dimensional material, a=4.

Thus, the diffusion coefficient D is given by the following equation:

$$D = \frac{{σ}_{x , t}^{2} - {σ}_{x , 0}^{2}}{4 t} \qquad ( 5 )$$

When t=τ, the diffusion distance is defined over the exciton lifetime and is given by the following equation:

$$L = 2 \sqrt{D τ} \qquad ( 6 )$$

Therefore, the exciton diffusion constants and diffusion distances of the few-layer WS₂ may be determined by fitting the TAM image with a Gaussian function. No obvious anisotropy is found in (a) of FIG. 4, and in the present disclosure, the x-axis direction may be selected to obtain the exciton diffusion of the few-layer WS₂. (b) of FIG. 4 shows histogram analysis of signal distribution along the center line in the TAM image, where all lines are described by the Gaussian function. (c) of FIG. 4 plots the Gaussian variation as a function of the pump-probe delay time of the original few-layer WS₂ sample. The experimental data are then fitted using equation (5) to obtain a diffusion coefficient D of 2.825 cm²s⁻¹. In addition, according to equation (6), the exciton diffusion distance may be determined as 340.53 nm.

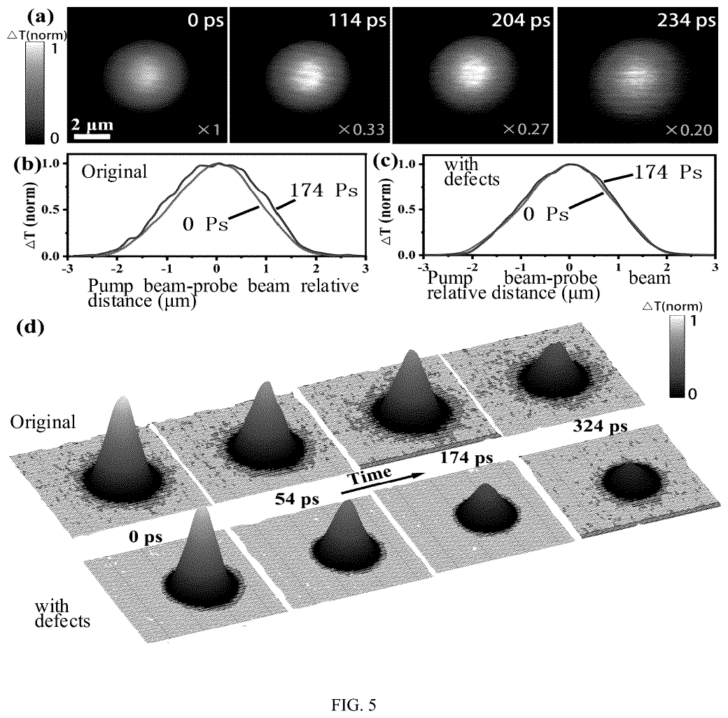

In order to compare the exciton transport in the original few-layer WS₂ sample and the few-layer WS₂ sample with defects, the original few-layer WS₂ sample is treated with continuous argon ion bombardment for 40 s at 10 W. The TAM image of the original few-layer WS₂ sample with defects is shown in (a) of FIG. 5, indicating that the overall distribution of excitons in the sample with defects has a smaller change compared to the original few-layer WS₂ sample in (a) of FIG. 4. At the same time, it is difficult to distinguish the spatial distribution of excitons in the few-layer WS₂ samples with defects (see (c) of FIG. 5). On the contrary, a clear exciton transport ((b) of FIG. 5) is observed in the original few-layer WS₂ sample, which indicates that defects have a great influence on the exciton transport.

The exterior view of the two-dimensional TAM image is shown in a three-dimensional (3D) space in (d) of FIG. 5. These 3D cones represent the changes of the overall exciton distribution of the original few-layer WS₂ sample and the original few-layer WS₂ sample with defects at different pump-probe delay times. At 0 ps, the 3D cones represent the total number of initial photo-generated excitons excited by the pump beam. The overall intensity of excitons of the original few-layer WS₂ sample with defects is slightly lower than that of the original few-layer WS₂ sample. At a later delay time, the total number of excitons decreases due to radiative recombination or non-radiative recombination. The total number of excitons in the original few-layer WS₂ sample with defects decays significantly faster than that in the original few-layer WS₂ sample. This is due to the fact that excitons may be trapped by defects, thus providing additional non-radiative relaxation channels. More notably, the excitons in the original few-layer WS₂ sample with defects are confined to a limited space. In contrast, the excitons in the original few-layer WS₂ sample diffuse away from the initial excitation volume, indicating that the defects may act as effective traps for the excitons and strongly affect the nature of exciton transport in the few-layer WS₂.

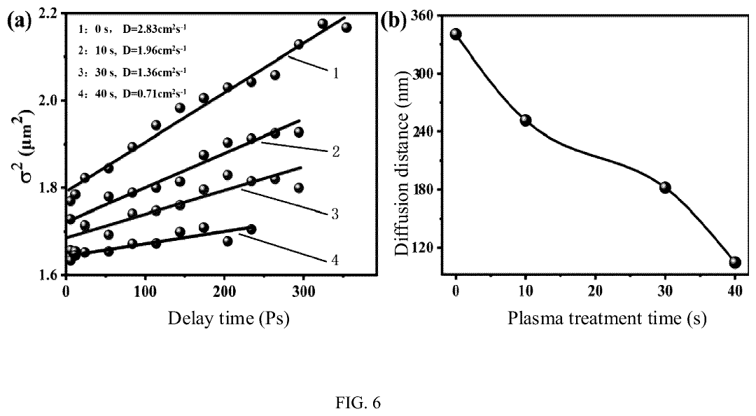

(a) of FIG. 6 shows the time evolution of the variance of the Gaussian distribution under different plasma treatment times (0 s, 10 s, 30 s, and 40 s), where the exciton diffusion coefficient decreases with the increase of the plasma treatment time. The diffusion coefficient for the plasma treatment time in 40 s is determined to be 0.71 cm²s⁻¹, which is about a quarter of that of the original few-layer WS₂ sample (2.83 cm2s−1). The exciton diffusion distance is then determined from equation (6), which is related to the diffusion coefficient and the exciton lifetime. Note that the exciton lifetime should include both radiative recombination and non-radiative recombination. Therefore, the average lifetime τₐᵥ=A₁τ₁+A₂τ₂ is used to calculate the diffusion distance. Table 1 lists exciton diffusion parameters of the original few-layer WS₂ sample at different plasma treatment times and fitting parameters of the transient absorption dynamic curves. (b) of FIG. 6 shows the change of the exciton diffusion distance with the plasma treatment time, which indicates that the defects may significantly reduce the diffusion distance by more than a factor of 3 from 340.53 nm to 104.50 nm.

Here the reduction of the exciton transport distance is attributed to defects, and accordingly it is derived that there may be a mechanism of interaction between defects and exciton diffusion in the few-layer WS₂. For the original TMDCs, it is known that the upper limit of exciton mobility of the original TMDCs is determined by exciton-phonon scattering. However, with the introduction of non-intrinsic defects, the exciton transport may be controlled by exciton scattering in the sample with defects. Argon plasma bombardment in (c) of FIG. 2 may produce atomic point defects. The defects act as a scattering center and trap neutral excitons to form bound excitons (as shown in (d) of FIG. 2). The scattering process provides an additional non-radiative relaxation channel for recombination of the neutral excitons. As a result, in (b) of FIG. 3 and Table 1, the average exciton lifetime changes faster as the plasma treatment time increases. At the same time, the defects impede transport of the neutral excitons, which leads to lower exciton diffusion coefficients in (d) of FIG. 5 and (a) of FIG. 6. The exciton diffusion distance shown by (b) of FIG. 6 decreases dramatically under the influence of defects. Therefore, the exciton diffusion distance may be optimized by extending the exciton lifetime or increasing the exciton diffusion coefficient.

TABLE 1
Fitting parameters and exciton diffusion parameters of TA dynamic curves
for original few-layer WS2 samples under different plasma treatment times

| P1asma time | τ₁ | A₁ | τ₂ | A₂ | τₐᵥ | D | L |
|---|---|---|---|---|---|---|---|
| (s) | (ps) | (100%) | (ps) | (100%) | (ps) | (cm²s⁻¹) | (nm) |
| 0 | 102.44 | 100 | 0 | 0 | 102.44 | 2.83 | 340.53 |
| 10 | 103.54 | 73.22 | 17.88 | 26.78 | 80.60 | 1.96 | 251.38 |
| 30 | 94.62 | 58.15 | 11.66 | 41.85 | 59.90 | 1.38 | 181.84 |
| 40 | 100.52 | 33.09 | 7.75 | 66.91 | 38.45 | 0.71 | 104.50 |

The above descriptions are merely exemplary embodiments of the present disclosure, and are not intended to limit the present disclosure. Any modifications, equivalent replacements, improvements, etc. made within the spirit and principles of the present disclosure shall fall within the scope of the present disclosure.

Those skilled in the art will appreciate that the embodiments of the present disclosure may be provided as methods, systems, or computer program products. Therefore, the present disclosure may take the form of a full hardware embodiment, a full software embodiment, or an embodiment combining software and hardware. Besides, the present disclosure may adopt the form of a computer program product implemented on one or more computer available storage media (including but not limited to a disk memory, a CD-ROM, an optical memory and the like) including computer available program codes.

The present disclosure is described with reference to the flow diagram and/or block diagram of the method, apparatus (system), and computer program product according to the embodiments of the present disclosure. It should be understood that each flow and/or block in the flow diagram and/or block diagram and the combination of flows and/or blocks in the flow diagram and/or block diagram may be implemented by computer program instructions. These computer program instructions may be provided to processors of a general-purpose computer, a special-purpose computer, an embedded processor or other programmable data processing devices to generate a machine, such that instructions executed by processors of a computer or other programmable data processing devices generate an apparatus for implementing the functions specified in one or more flows of the flow diagram and/or one or more blocks of the block diagram.

These computer program instructions may also be stored in a computer-readable memory capable of guiding a computer or other programmable data processing devices to work in a specific manner, such that instructions stored in the computer-readable memory generate a manufactured product including an instruction apparatus, and the instruction apparatus implements the functions specified in one or more flows of the flow diagram and/or one or more blocks of the block diagram.

These computer program instructions may also be loaded on a computer or other programmable data processing devices, so that a series of operation steps are executed on the computer or other programmable devices to produce computer-implemented processing, and thus, the instructions executed on the computer or other programmable devices provide steps for implementing the functions specified in one or more flows of the flow diagram and/or one or more blocks of the block diagram.

Specific embodiments are used in the present disclosure to illustrate the principles and implementations of the present disclosure, and the descriptions of the above embodiments are merely used to help understand the method of the present disclosure and the core idea thereof. Meanwhile, for those of ordinary skill in the art, changes may be made to the specific implementations and applications in light of the idea of the present disclosure. In view of the above, the specification should not be construed as limiting the present disclosure.

1. A method for monitoring the influence of defects in a few-layer two-dimensional material on exciton transport, comprising:
measuring a pre-acquired original few-layer two-dimensional material sample using a transient absorption microscope to obtain a first transient absorption dynamic curve;
fitting the first transient absorption dynamic curve to obtain a first exciton lifetime of the original few-layer two-dimensional material sample;
acquiring first TAM images of exciton densities of the original few-layer two-dimensional material sample at different delay times by using a pump beam and a probe beam of the transient absorption microscope;
fitting the first TAM images using a Gaussian function to determine a first diffusion coefficient and a first diffusion distance of excitons in the original few-layer two-dimensional material sample;
performing plasma treatment on the original few-layer two-dimensional material sample for different durations, and measuring the plasma-treated original few-layer two-dimensional material sample using the transient absorption microscope to obtain a second transient absorption dynamic curve;
fitting the second transient absorption dynamic curve using a double exponential function to obtain a second exciton lifetime of the plasma-treated sample;
acquiring second TAM images of exciton densities of the plasma-treated sample at different delay times by using the pump beam and the probe beam of the transient absorption microscope;
fitting the second TAM images using the Gaussian function to determine a second diffusion coefficient and a second diffusion distance of excitons in the plasma-treated sample; and
monitoring the influence of the defects on exciton transport based on the first exciton lifetime, the first diffusion coefficient, the first diffusion distance, the second exciton lifetime, the second diffusion coefficient and the second diffusion distance.

2. The method according to claim 1, wherein the acquiring the first TAM images of exciton densities of the original few-layer two-dimensional material sample at different delay times by using the pump beam and the probe beam of the transient absorption microscope comprises:
fixing a position of the pump beam of the transient absorption microscope, irradiating the original few-layer two-dimensional material sample by the pump beam, and scanning the original few-layer two-dimensional material sample by the probe beam, to acquire the first TAM images of exciton densities at different delay times.

3. The method according to claim 1, wherein the acquiring the second TAM images of exciton densities of the plasma-treated sample at different delay times by using the pump beam and the probe beam of the transient absorption microscope comprises: irradiating the plasma-treated sample by the pump beam, and scanning the plasma-treated sample by the probe beam, to acquire the second TAM images of exciton densities at different delay times.

4. The method according to claim 1, wherein the monitoring the influence of the defects on exciton transport based on the first exciton lifetime, the first diffusion coefficient, the first diffusion distance, the second exciton lifetime, the second diffusion coefficient and the second diffusion distance comprises: comparing the first exciton lifetime, the first diffusion coefficient and the first diffusion distance with the second exciton lifetime, the second diffusion coefficient and the second diffusion distance that are under different defect concentrations, respectively, to monitor a change of the diffusion distance under different defect concentrations.

5. The method according to claim 1, wherein the performing plasma treatment on the original few-layer two-dimensional material sample for different durations comprises: processing the original few-layer two-dimensional material sample in argon plasma of 10 W at a radio frequency of 13.56 MHz.

6. The method according to claim 1, further comprising: identifying defects that are introduced by performing the plasma treatment on the original few-layer two-dimensional material sample for different durations.

7. The method according to claim 6, wherein the identifying the defects that are introduced by performing the plasma treatment on the original few-layer two-dimensional material sample for different durations comprises: characterizing, after performing the plasma treatment on the original few-layer two-dimensional material sample for different durations, sample defects by an atomic resolution scanning transmission electron microscope and a photoluminescence technique to determine whether the defects have been introduced.

8. The method according to claim 1, wherein during the fitting the first TAM images using the Gaussian function to determine the first diffusion coefficient and the first diffusion distance of the excitons in the original few-layer two-dimensional material sample, the total number n (x, y, t) of the excitons is:
$$\frac{n ( x , y , t )}{\partial t} = D [ \frac{\partial {n}^{2} ( x , y , t )}{\partial {x}^{2}} + \frac{\partial {n}^{2} ( x , y , t )}{\partial {y}^{2}} ] - \frac{n ( x , y , t )}{τ}$$
where D denotes the first diffusion coefficient, n (x, y, t) denotes the total number of the excitons of a function with time t and position (x, y), and τ denotes an exciton lifetime and comprises radiative recombination and non-radiative recombination.

9. The method according to claim 1, wherein the few-layer two-dimensional material is few-layer WS₂.

10. The method according to claim 1, wherein the pump beam has a wavelength of 400 nm and an energy density of 3.20 μJ/cm², and the probe beam has a wavelength of 625 nm and an energy density of 0.19 μJ/cm².
